(19) United States
(12) Patent Application Publication
(10) Pub. No.: US 2021/0131146 A1
(43) Pub. Date: May 6, 2021

(54) LOCK

(71) Applicant: ABUS August Bremicker Söhne KG, Wetter-Volmarstein (DE)

(72) Inventors: Marcus Kuchler, Munich (DE); Manuel Thomas, Schwelm (DE)

(21) Appl. No.: 17/089,015

(22) Filed: Nov. 4, 2020

(30) Foreign Application Priority Data
Nov. 6, 2019 (DE) 102019129960.8

(51) Int. Cl. E05B 67/00; B62H 5/00; B62J 11/04

(52) U.S. Cl. CPC E05B 67/006; E05B 37/02; B62J 11/04; B62H 5/003

(57) ABSTRACT

A lock, in particular a bicycle lock, includes a lock body, a locking element located outside the lock body, and a locking mechanism located outside the lock body for receiving and locking the locking element. The locking mechanism is connected to the lock body by a first rope section and the locking element is connected to the lock body by a second rope section. A length of a part of at least one of the rope sections extending outside the lock body is variable.

### CROSS-REFERENCE TO RELATED APPLICATIONS

The present disclosure claims priority to German Patent Application No. 102019129960.8 filed Nov. 6, 2019, the contents of which are incorporated by reference herein.

### TECHNICAL FIELD

The present disclosure relates to a lock, in particular to a bicycle lock, comprising a lock body; a locking element; and a locking mechanism for receiving and locking the locking element.

### BACKGROUND

Such a lock can in particular be used to secure a bicycle between two trips against an unauthorized riding away or removal. Locks to be used in such a manner are usually provided separately from the bicycle and have to be taken along on the travel to be able to protect the bicycle against theft attempts during a parking. This can, for example, take place by U-hoop locks that have a U-shaped hoop as a locking element that can selectively be locked in or released from the lock body. Furthermore, so-called articulated locks or folding locks that have a jointed bar hoop, which is selectively lockable to the lock body and has a plurality of pivotably mutually connected jointed bars, can be used for the securing of bicycles. In such locks, a loop by which the bicycle can be securely connected to an object, for example to a bicycle stand or a lantern, can be formed by the respective hoop in the locked state. Rope locks or chain locks comprising ends that are lockable to one another can also be used to secure a bicycle to a stationary object.

However, the separate taking along of a lock frequently represents an unwanted effort, in particular with bicycles used for sports such as racing bikes or mountain bikes. Holders that are attachable to bicycle frames can therefore be provided to facilitate the transport of the locks. However, such holders require a space at the bicycle frame that is to be exclusively provided therefor and that is then no longer available for attaching a bottle holder, for example. In addition, common bicycle locks usually have a relatively high weight to be able to provide sufficient theft protection. Frame locks, which are formed directly at a bicycle frame and enable a securing of the bicycle by leading a hoop through the spokes of the rear wheel of the bicycle to restrict its rotational movement, in turn require special designs of the bicycle frame so that bicycles and in particular racing bikes generally cannot be retrofitted with such locks. Furthermore, frame locks can indeed prevent a direct riding away with the bicycle, but they cannot connect the bicycle to a stationary object. Such frame locks therefore cannot provide any protection against a removal or a loading of the bicycle on a subsequent breaking open of the lock.

It is therefore an object of the present disclosure to provide a lock that provides protection of bicycles against an unauthorized removal and that is compact and comfortable to transport and easy and quick to operate.

### SUMMARY

This object is satisfied by a lock having the features of the present disclosure and in particular in that the locking element and the locking mechanism are located outside the lock body, wherein the locking mechanism is connected to the lock body by a first rope section and the locking element is connected to the lock body by a second rope section, and wherein the length of a part of at least one of the rope sections extending outside the lock body is variable.

Since the locking mechanism and the locking element are arranged outside the lock body, the lock body can be particularly compact since, unlike in most common bicycle locks, the lock body does not have to provide any space for the arrangement in particular of the components of the locking mechanism.

Instead, the lock body can mainly be used to receive at least one part of the at least one rope section and in particular of both rope sections or to provide a connection for the rope sections and thereby ultimately for the locking mechanism and the locking element. For this purpose, the first rope section and the second rope section can in particular run into the lock body so that the lock body can form a store for the rope sections out of which the rope sections can be selectively drawn to extend the length of their parts extending outside the lock body. This can, for example, make it possible to position a large part of the or each rope section within the lock body during a transport in order to position the locking mechanism and the locking element as close as possible to the lock body and to be able to bring the lock into a compact arrangement that does not hinder the travel.

Since the locking element can be received by the locking mechanism and can be locked at or in the locking mechanism, the two rope sections can also be securely connected to one another. In this connected state of the locking mechanism and the locking element, the lock can consequently form a closed loop, wherein the size of said closed loop can be flexibly adapted to the respective conditions by a change of the length of a part of at least one of the rope sections extending outside the lock body in order, for example, to connect a bicycle to a stationary object.

The length of the part of a rope section extending outside the lock body can, for example, be variable in that a part of the rope section extending within the lock body can be drawn out of said lock body. Furthermore, it is possible to form the rope section as elastic to be able to achieve the desired loop size. In both cases, the securing of the bicycle can take place extremely quickly in that the respective element connected to the rope section is led around an object by a change of the length of the part of the rope section extending outside the lock body and the locking mechanism and the locking element are thereupon connected to one another.

The rope section can in particular be a section of a wire rope that is arranged within the lock body and extends out of it. Such a wire rope can have a relatively small diameter, for example between 1.6 mm and 2.4 mm, to be able to achieve a particularly compact design of the lock with as small a weight as possible. In particular on a use of the lock for bicycles used for sports, which are frequently only parked during short breaks and in the field of view of the rider, for example during a visit to a café, sufficient protection against a direct and unauthorized riding away or removal can thereby be achieved with a minimal weight of the lock. Furthermore, the rope section can be formed by a chain, in particular by a delicate chain, or can at least partly be produced from a plastic.

Such a lock can consequently be formed as compact and with a small weight and allows a fast and simple operation, in particular for a short-term securing of a bicycle. Furthermore, such a lock can be fastened to a bicycle frame to provide a simple and comfortable transport possibility. The lock can in this respect in particular be attached to a bicycle frame by fastening screws screwed into bores provided for the fastening of a bottle holder. In this respect, the compact design of the lock can enable a common attachment to a bottle holder and an arrangement between the bicycle frame and the bottle holder so that the lock can be taken along without noticeable restrictions in the use of the bicycle as will be explained in the following.

Further developments of the present disclosure can be seen from the description and the Figures.

In accordance with some embodiments, the length of a part of each rope section extending outside the lock body can be variable. The size of the loop to be formed by the connection of the locking mechanism to the locking element can thereby be quickly and flexibly adapted. For example, the locking element and the locking mechanism can thereby, starting from a bicycle or the lock body attached thereto, be brought together behind a stationary object such as a lantern or a fence and can be connected to one another there without one of the elements having to be completely led around the object used for the securing.

Provision can be made that the or each rope section can be drawn out of the lock body to change the length of its part extending outside the lock body. The lock body can thus so-to-say form a store for the or each rope section out of which the or each rope section can be drawn to form a loop having the desired size. The desired loop size can in this respect be achieved by a simple pulling movement and accordingly in a fast and uncomplicated manner.

In accordance with some embodiments, the or each rope section can be connected to a drawing-in device arranged within the lock body for drawing in the rope section. Such a drawing-in device can exert a force directed into the lock body onto the respective rope section so that the rope section can, for example, be automatically drawn into the lock body after a use of the lock for securing a bicycle and the length of its part extending outside the lock body is reduced. The element connected to the respective rope section, the locking mechanism, or the locking element can be arranged as close as possible to the lock body by this drawing in of the rope section so that the lock can, for example, be brought into a compact arrangement, which does not hinder the travel, for a transport.

The drawing-in device can be configured to draw the or each rope section into the lock body, automatically or due to an action to be performed by the user, on a release of the connection between the locking element and the locking mechanism. For example, the drawing in can take place as a result of a jerk-like pulling at a rope section or a button to be pressed by a user can be provided at an outer side of the lock body to start the drawing in of the rope section.

The drawing-in device can have a coil for winding up the at least one rope section and can in particular have a first coil for winding up the first rope section and a second coil for winding up the second rope section. The at least one rope section and in particular both rope sections can thereby generally be arranged wound up within the lock body, wherein the length of the respective part extending outside the lock body can be increased in a simple manner by a drawing of the rope section out of the lock body and by an unwinding from the coil that is thereby caused. Furthermore, the winding up of the rope sections enables their compact arrangement within the lock body and thereby the reception of relatively long rope sections to form large loops with an extent of the lock body that is as small as possible.

Provision can be made that the or each coil comprises a spring whose spring force counteracts an unwinding of the associated rope section, with the spring in particular being able to be configured as a spiral spring. An automatic drawing of the rope section into the lock body can be achieved in a simple manner by such a spring. The or each coil can in this respect in particular be configured as spring coils so that the coils can, for example, be directly formed by respective spiral springs around which the rope sections are wound.

The windings of the or each wound rope section can be disposed in a respective winding plane. For example, the windings can extend spirally around an axis that can in particular correspond to an axis of rotation about which the respective coil can be rotated and which can be oriented normally to the winding plane. In the direction of this axis or perpendicular to the winding plane, the extent of the wound rope section can thus be minimized and can in particular be substantially predefined by the diameter of the rope section or correspond thereto. In this respect, both rope sections can be wound up in a common winding plane so that the lock body forming a store for the rope sections can also primarily extend along the winding plane and can only have a small extent perpendicular to this plane. The lock body can thereby be flat and can, for example, be formed perpendicular to the winding plane with an extent of less than 2 cm. Such a flat design of the lock body can in particular make it possible for the lock to be attached in a space-saving manner between a bottle holder and a bicycle frame, wherein the flat lock body only causes a slight shift of the position of the bottle holder without impairing the other use of the bicycle.

The lock body can form a housing for the or each coil and for the or each rope section to be wound. The housing can in this respect have a rear housing part and a front housing part that are connected to one another along a division plane, with the division plane being able to be aligned in parallel with the winding plane or being able to correspond to the winding plane. Such a housing can in particular protect the components arranged within it against an external access and can ensure a correct and controlled arrangement of the or each coil and of the wound rope sections.

Furthermore, the design of the housing with a rear housing part and a front housing part can enable a simple and fast assembly of the lock. Due to the division of the housing along a division plane that is aligned in parallel with the winding plane, the coils provided can, for example, first be inserted into the rear housing part and the respective rope sections can be wound up. The rope sections thus do not have to be threaded into a closed housing in a complicated and time-consuming manner. After the arrangement in particular of all the components of the lock body in the rear housing part, the assembly can be completed by a simple connection of both housing parts to one another, wherein the housing parts can, for example, be welded to one another or can alternatively or additionally be connected to one another in a force-fitting and/or form-fitting manner.

In accordance with some embodiments, the drawing-in device can comprise a fixing device that is configured to block the drawing in of the or each rope section. For example, such a fixing device can be provided to block the drawing in of a respective rope section after a drawing out of the rope section for changing the length of its part extending outside the lock body and for forming a loop so that the part of the rope section extending outside the lock body remains at the desired length. It is thereby not necessary for a user to exert a permanent pull on the rope section during the forming of a loop for securing a bicycle in order to prevent a drawing in. Rather, the rope sections can be drawn out of the lock body up to a desired length comfortably and in particular successively and can thereupon be connected to one another via the locking mechanism and the locking element.

The blocking of the drawing in of the or each rope section by the fixing device can be selectively suspended. The drawing in of the respective rope section can take place due to such a suspension. For example, before a transport of the lock or before a trip with the bicycle, the blocking effect of the fixing device can be canceled by a jerk-like or an impulsive pulling at the respective rope section so that it is drawn into the lock body by the drawing-in device and the length of the part extending outside the lock body is minimized.

The fixing device can have a first blocking device for the first rope section that is configured to block the part of the first rope section extending outside the lock body at a predefinable length; and the fixing device can have a second blocking device for the second rope section that is configured to block the part of the second rope section extending outside the lock body at a predefinable length. For example, the blocking devices can block the length of the respective part of the associated rope section extending outside the lock body as a consequence of a continuous drawing out of the lock body and can prevent a drawing of the rope section into the lock body. For this purpose, the blocking device can comprise a blocking element that is held in engagement with the rope section due to the force exerted onto the rope section by the drawing-in device and that can be brought out of engagement with the rope section by a brief suspension of this force, for example by a jerk-like pulling at the rope section, to release said rope section for a drawing into the lock body. The blocking of the drawing-in device by the fixing device can thereby, similarly to roller shutters or cable reels, first take place automatically and without actions to be performed by the user after a drawing out of the rope sections and can be selectively canceled in a simple manner by the user.

Alternatively to this, the blocking devices can, for example, have respective blocking elements that are arranged within the lock body and in the vicinity of inlet openings, through which the rope sections run into the lock body, and that can in particular be spring-preloaded into the lock body in a manner perpendicular to a straight-line direction of entry of the rope sections. Due to this spring preload of the blocking elements, the rope sections drawn out of the lock body can be clamped between the respective blocking element and an inner housing wall formed by the lock body in order to block the respective rope section at a desired length of its part extending outside the lock body. To suspend the blocking effect of blocking elements configured in this manner and to release the rope sections for a drawing into the lock body, a user can, for example, bring the rope sections into an orientation extending obliquely to the direction of entry after the use of the lock for securing the bicycle in order to transfer a force acting against the spring preload to the blocking elements by the rope sections. The blocking elements can thereby be pushed back against the spring preload so that the released rope sections can be drawn into the lock body in a controlled manner and can in particular be wound around respective coils. Similarly, it is possible to provide a button or push-button, in particular a respective button or a push-button, at the outer side of the lock body by which a user can selectively push back such spring-preloaded blocking elements in order to release the rope sections for a drawing into the lock body.

The or each rope section can terminate in a rope end within the lock body, said rope end being connected to a coil rotatable about an axis of rotation. The rope sections can thereby be wound onto the coils and arranged in a space-saving manner within the lock body. These coils can in particular form components of the drawing-in device already mentioned above and can comprise or be formed by springs exerting a force directed into the lock body. Alternatively or in addition to this, such a coil can, for example, be manually rotatable by a user to enable a winding of the rope sections.

The first rope section can terminate in a first rope end within the lock body, said first rope end being connected to a first coil rotatable about a first axis of rotation and the second rope section can terminate in a second rope end within the lock body, said second rope end being connected to a second coil rotatable about a second axis of rotation. In this respect, the first rope section is consequently provided separately from the second rope section so that the rope sections can be handled completely independently of one another and the lengths of their parts extending outside the lock body can be changed flexibly. The locking element and the locking mechanism can also thereby be moved independently of one another to be able to connect the rope sections in a simple and fast manner to form a loop.

The first axis of rotation and the second axis of rotation can be aligned in parallel with one another and the spacing of the first axis of rotation from the second axis of rotation can amount to between 60 mm and 70 mm, in particular to approximately 65 mm. The spacing of the first axis of rotation from the second axis of rotation can thus, within the framework of production tolerances, just correspond to the standard spacing between the threaded bores typically provided at a bicycle frame for fastening bottle holders. This makes it possible to attach the lock or the lock body to a bicycle frame by fastening screws screwed into such threaded bores and extending coaxially to the axes of rotation. The extent of the lock body between the bores, which is anyway necessary for such an assembly of the lock, can in this respect be utilized for the arrangement of the wound rope sections due to the spacing of the axes of rotation from one another that is adapted to said extent. Furthermore, the winding up of the rope sections can be achieved by a parallel alignment of the axes of rotation in a common winding plane so that the lock body can be flat and can be attached together with a bottle holder between the bottle holder and a bicycle frame by common fastening screws without the position of the bottle holder thereby shifting with impairment or such a bottle holder having to be omitted.

Provision can be made that the first coil and the second coil are connected to one another via a connection element, in particular a metal plate. Such a connection element can in particular ensure the correct arrangement of the coils with respect to one another and can increase the stability of the lock, in particular against attempted break-ins.

In accordance with some embodiments, the lock body can have a first fastening passage and a second fastening passage for leading through fastening screws, with the first fastening passage extending coaxially to the first axis of rotation and the second fastening passage extending coaxially to the second axis of rotation. The lock body can in particular be fastened to a bicycle frame by the fastening screws in bores provided for the attachment of a bottle holder. In this respect, the fastening passages can in particular be circular in cross-section and can have a diameter of between 4 mm and 5 mm, or between 4.3 mm and 4.5 mm. The diameter of the fastening passages can thus correspond to or be adapted to the standard diameter of the threaded bores typically provided at a bicycle frame for the fastening of bottle holders to enable the attachment of the lock in a simple manner by typical fastening screws.

In accordance with some embodiments, sealing elements can be provided for sealing inlet openings of the rope sections into the lock body. Such sealing elements can, for example, be ring-shaped or cylindrical and can in particular be produced from a rubber or a soft plastic to be able to reliably prevent the entry of dirt or water into the lock body. The sealing elements can in particular be configured to receive in a form-fitting manner a contact section of the element, of the locking mechanism or of the locking element, connected to the respective rope section and thereby to hold it at the lock body. A noise formation due to a knocking against one another or a rattling of the elements at one another or at the lock body during a transport can thereby be counteracted.

The locking mechanism can be configured as a combination locking mechanism. Such a combination locking mechanism can have a plurality of code rings which are rotatable about an axis of rotation and by which a secret code, for example comprising a sequence of numbers, symbols or colors, can be selected and can be set to be able to release the locking element connected to the locking mechanism from the latter. The locking element can in contrast be locked to the locking mechanism by an adjustment of the secret code. Such a combination locking mechanism can in particular be operated without a key so that the taking along of such a mechanism for the use of the lock can be omitted and the risk can be counteracted of no longer being able to use the lock if a key is lost.

The lock body can have a holder for the locking mechanism and/or the locking element. The locking element and the locking mechanism can thereby be securely connected to the lock body, in particular during a transport or during a trip with a bicycle, in order, for example, to be able to prevent a noise formation or damage due to an abutment of said elements at the lock body.

The holder can be formed as at least partly elastically deformable and in particular such that the locking mechanism and/or the locking element can be clipped into the holder. The locking element or the locking mechanism can thereby be simply and quickly connected to the holder or removed therefrom to be able to achieve either a compact arrangement of the lock during a transport or a quick availability for the securing, in particular the securing of a bicycle.

The present disclosure further relates to a bicycle comprising a bicycle frame having two threaded bores for fastening a bottle holder; a bottle holder that is fastened to the bicycle frame by two fastening screws associated with the threaded bores; and a lock as described above that is arranged between the bottle holder and the bicycle frame and that is attached to the bicycle frame by the fastening screws. A lock arranged at the bicycle in such a manner can be transported in a simple manner and can be used for a comfortable and fast securing of the bicycle without restrictions with respect to the other use of the bicycle or without taking up an unreasonably large space. Furthermore, in the described arrangement, such a lock can be comfortably attached to a bicycle frame by the threaded bores anyway provided for the bottle holder without any special precautions being necessary for this purpose.

### BRIEF DESCRIPTION OF THE DRAWINGS

The present disclosure will be described in the following purely by way of example with reference to an embodiment and to the drawings. There are shown:

FIG. 1 a perspective view of a lock in a completely assembled state;

FIG. 2 a perspective view of the lock with a removed front housing part;

FIG. 3 a perspective view of an arrangement of a bottle holder and the lock for their joint attachment to a bicycle frame;

FIG. 4 a front view of the lock attached to a bicycle frame together with the bottle holder;

FIG. 5A a schematic representation of a section of a lock body for illustrating a fixing device in a blocked state; and

FIG. 5B a schematic representation of a section of a lock body for illustrating the fixing device in an unblocked state.

### DETAILED DESCRIPTION

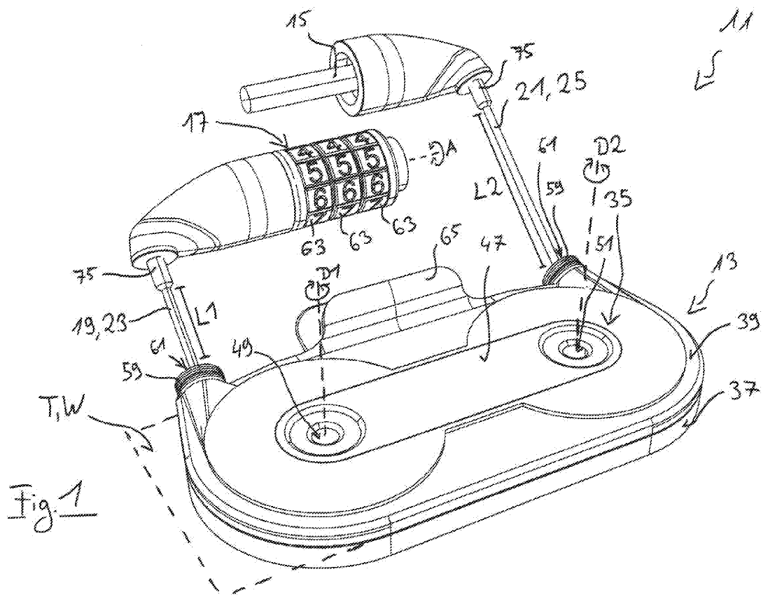

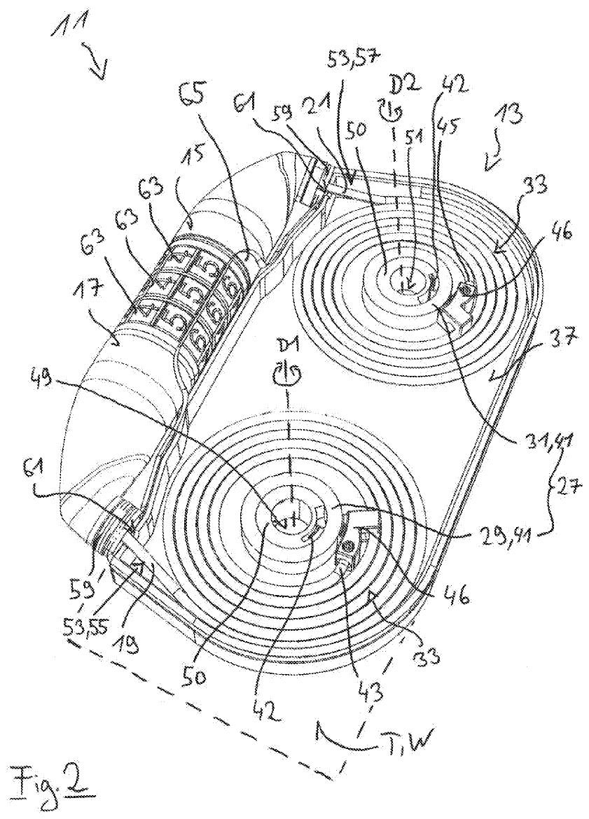

FIG. 1 shows a perspective front view of a lock 11 that has a lock body 13 as well as a locking mechanism 17 arranged outside the lock body 13 and a locking element 15 likewise arranged outside the lock body 13. The locking mechanism 17 is in this respect connected to the lock body 13 by a first rope section 19 and the locking element 15 is connected to the lock body 13 by a second rope section 21, wherein the rope sections 19 and 21 can in particular be formed by wire ropes. Furthermore, the locking mechanism 17 is configured to receive and to lock the locking element 15 to be able to form a closed loop from the lock body 13 and from the rope sections 19 and 21 and to be able to secure a bicycle to a stationary object (cf. also FIGS. 2 to 4).

The locking mechanism 17 is configured as a combination locking mechanism and has three code rings 63 that are rotatable about an axis of rotation A. A secret code comprising three numbers can be set or adjusted by these code rings 63. Whereas the locking element 15 connected to the locking mechanism 17 can be released from the locking mechanism 17 by setting the secret code (cf. FIG. 1), the locking element 15 can be securely locked to the locking mechanism 17 by a rotation of the code rings 63 and an adjustment of the secret code (cf. FIGS. 2 to 4).

Furthermore, the first rope section 19 and the second rope section 21 run into the lock body 13 through respective inlet openings 61. In this respect, the length L1 of the part 23 of the first rope section 19 extending outside the lock body 13 and the length L2 of the part 25 of the second rope section 21 extending outside the lock body 13 can be changed selectively and independently of one another in that the first rope section 19 and the second rope section 21 can be pulled out of the lock body 13.

This, for example, makes it possible to increase the length L2 of the part 25 of the second rope section 21 extending outside the lock body 13 such that the locking element 15 can be led around a stationary object, such as a lantern or a bicycle stand, and can thereupon be connected to the locking mechanism 17 to secure a bicycle to the object through the loop formed by the lock 11. Since the length L1 and thus the spacing between the locking mechanism 17 and the lock body 13 is also variable, both rope sections 19 and 21 can be flexibly drawn out of the lock body 13 as far as desired so that the locking mechanism 17 and the locking element 15 can, for example, be brought together behind an object used for securing and can be connected to one another there.

The lock body 13 forms a housing 35 for the parts of the rope sections 19 and 21, not visible in FIG. 1, extending within the lock body 13 so that these parts are protected against an external access. In this respect, the housing 35 has a front housing part 39 and a rear housing part 37 that are connected to one another along a division plane T. The inlet openings 61, through which the first rope section 19 and the second rope section 21 run into the lock body 13, are sealed by respective sealing elements 59 to be able to reliably prevent an entry of water or contaminants into the interior of the lock body 13 and damage that is caused thereby to the components arranged in the lock body 13. Furthermore, the sealing elements 59, which can in particular be produced from a rubber or a soft plastic, are configured to receive a respective contact section 75 of the locking mechanism 17 or of the locking element 15 in a form-fitting manner to be able to counteract a disturbing rattling due to a knocking against one another of these elements 15 and 17 at one another or at the lock body 13 during a transport of the lock 11 (cf. also FIGS. 2 to 4).

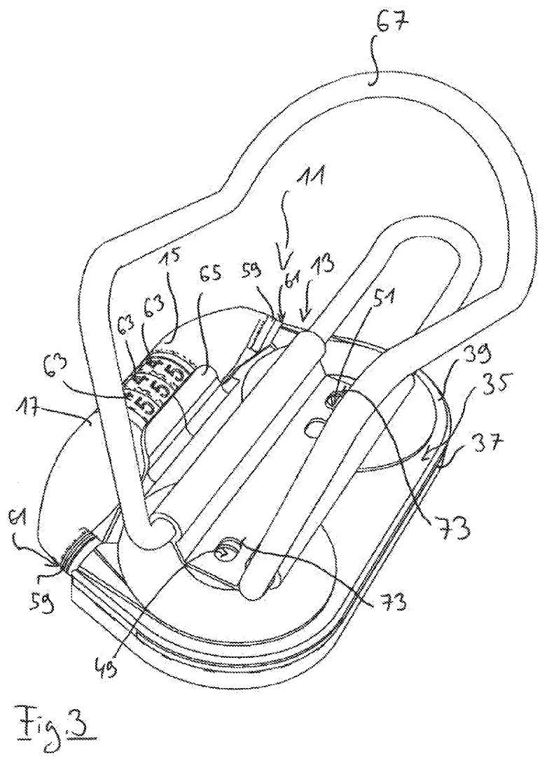

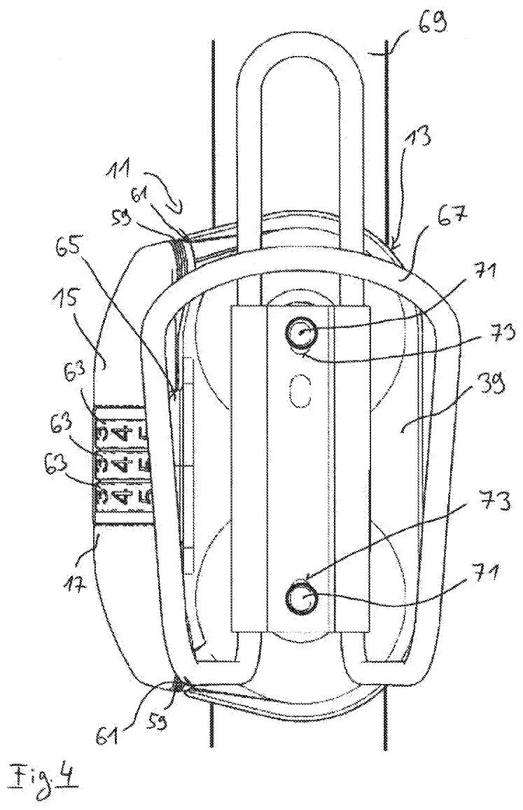

Furthermore, the lock body 13 has a first fastening passage 49 and a second fastening passage 51 through which fastening screws 71 for fastening the lock 11 can be led. The spacing between the two fastening passages 49 and 51 is in this respect in particular selected such that the lock 11 can be fastened to a bicycle frame 69 by the fastening screws 71 by screwing the fastening screws 71 into threaded bores that are formed at the bicycle frame 69 and that are anyway provided for attaching a bottle holder 67 (cf. FIG. 4). The lock 11 can in this respect in particular be fastened to the bicycle frame 69 together with the bottle holder 67 in a space-saving manner, wherein the lock 11 can be arranged between the bottle holder 67 and the bicycle frame 69 (cf. FIGS. 3 and 4). For this purpose, the elongate holes 73 of the bottle holder 67 provided for the leading through of fastening screws 71 can be arranged in alignment with the fastening passages 49 and 51 so that the fastening screws 71 can be led through the elongate holes 73 and the fastening passages 49 and 51 in order to attach both the bottle holder 67 and the lock 11 to the bicycle frame 69. The lock 11 can thereby be taken along in a simple manner during a trip with the bicycle without its attachment to the bicycle frame 69 requiring special precautions or restricting the use of the bicycle.

Whereas the separate arrangement of the locking mechanism 17 and the locking element 15 shown in FIG. 1 makes it possible to draw the rope sections 19 and 21 connected thereto out of the lock body 13 up to a respective desired length L1 and L2 in order to form a loop by the lock 11, FIGS. 2 to 4 show a compact arrangement of the lock 11 with the locking element 15 connected to the locking mechanism 17. This arrangement can in particular be provided during a transport of the lock 11. The rope sections 19 and 21 are in this respect completely drawn into the lock body 13 so that the locking mechanism 17 and the locking element 15 are arranged at a spacing from the lock body 13 that is as small as possible. Furthermore, the locking mechanism 17 and the locking element 15 connected thereto are clipped into a holder 65 formed at the lock body 13, for which purpose this holder 65 is adapted to the shape of the locking mechanism 17 and of the locking element 15 and is formed as at least partly elastic. A noise formation during a transport of the lock 11, for example during a trip with the bicycle, due to a rattling of components of the lock 11 at one another can in particular be prevented by the reception of the locking mechanism 17 and the locking element 15 in the holder 65.

As can be seen in FIG. 2, which shows the lock 11 with the front housing part 39 removed, the first rope section 19 terminates in a first rope end 43 within the lock body 13, said first rope end 43 being connected to a first coil 29 via a fastening element 46. Similarly, the second rope section 21 terminates in a second rope end 45 that is connected to a second coil 31 via an associated fastening element 46. Both coils 29 and 31 are formed by springs 41 that are configured as spiral springs and that are rotatable about a first axis of rotation D1 and a second axis of rotation D2 respectively. In some embodiments, the first coil 29 and the second coil 31 are connected by a connection element 47 (cf. FIG. 2). In some embodiments, the connection element 47 may be a metal plate. The connection element 47 allows for the correct arrangement of the first coil 29 and the second coil 31 with respect to one another, increase the stability of the lock 11, in particular, the connection element 47 may increase the stability of the lock 11 against attempted break-ins.

Starting from the first rope end 43 or the second rope end 45, the first rope section 19 and the second rope section 21 are arranged in respective windings 33 around the corresponding coil 29 or 31 within the lock body 13. In this respect, the coils 29 and 31 are arranged at an outer side of respective boundaries 50 which are formed by the lock body 13 and whose inner sides define the fastening passages 49 or 51. The inwardly disposed spring ends 42 of the coils 29 and 31 or of the springs 41 forming them are connected to the boundaries 50 so that the spring force of the springs 41 counteracts an unwinding or a drawing of the associated rope section 19 or 21 out of the lock body 13. Thus, the coils 29 and 31 form a drawing-in device 27 by which the rope sections 19 and 21 can be automatically drawn into the lock body 13.

It can be achieved by this drawing in that, on a transfer of the lock 11 into the transport state shown in FIGS. 2 to 4, the rope sections 19 and 21 are drawn into the lock body 13 in a controlled and automatic manner and are wound up in a compact and space-saving manner there. The windings 33 of the rope sections 19 and 21 are in this respect arranged in a common winding plane W so that the windings 33 extend spirally around the respective axis of rotation D1 or D2 and have a minimum extent in the direction of the axes of rotation D1 and D2 aligned in parallel with one another. The lock body 13 can thereby also be designed with a small extent in this direction and the housing 35 can be correspondingly flat so that the lock 11 can be comfortably attached between the bicycle frame 69 and the bottle holder 67 without the use of the bottle holder 67 thereby being impaired (cf. FIGS. 3 and 4). The arrangement of the rope sections 19 and 21 in spirally extending windings 33 within the lock body 13 furthermore makes it possible to arrange relatively long rope sections 19 and 21 within the lock body 13 with a relatively small space requirement in the winding plane W.

In the embodiment shown in FIG. 2, the drawing-in device 27 is configured such that the coils 29 and 31 permanently exert a force directed into the lock body 13 onto the rope sections 19 and 21. Alternatively to this, provision can be made to form the drawing-in device 27 with a fixing device 53 that comprises a first blocking device 55 for the first rope section 19 and a second blocking device 57 for the second rope section 21. Possible positions for arranging such a fixing device 53 in the lock body 13 are indicated by the arrows associated with the reference numerals. Such blocking devices 55 and 57 can, for example, be configured to block the rope sections 19 and 21 independently of one another at a desired length L1 or L2 of the parts 23 and 25 extending outside the lock body 13 (cf. FIG. 1). For this purpose, the blocking devices 55 and 57 can comprise a respective blocking element that, as a result of a continuous drawing of the associated rope section 19 or 21 out of the lock body 13, comes into engagement with the respective rope section 19 or 21 to prevent a drawing in thereof due to the force exerted by the drawing-in device 27. Such a blocking element can, for example, be brought out of engagement with the rope section 19 or 21 by a deliberate, jerk-like or impulsive pulling of the user at the respective rope sections 19 or 21, similarly to a roller shutter, so that the rope section 19 or 21 can be drawn into the lock body 13 and can be wound around the respective coil 29 or 31.

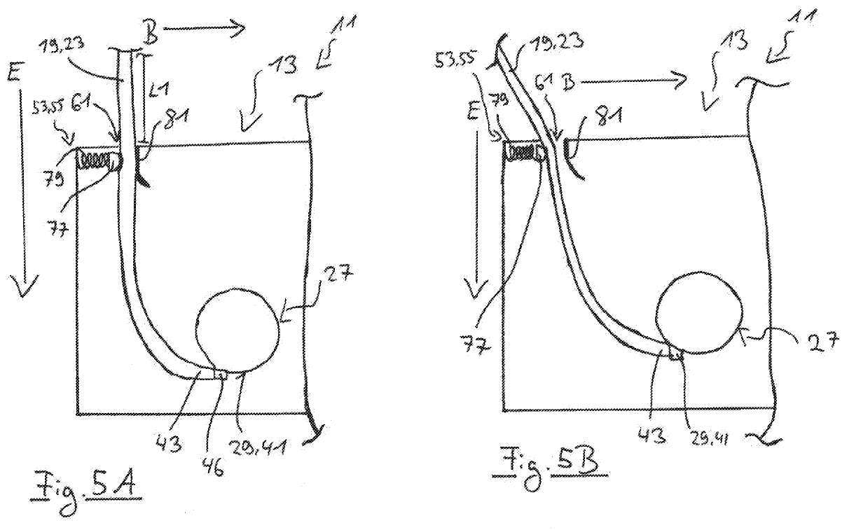

FIGS. 5A and 5B illustrate a further possibility for the formation of a fixing device 53. They show respective schematic representations of a section of a lock body 13 of a lock 11 into which a first rope section 19 runs through an inlet opening 61. In turn, a first rope end 43 of the first rope section 19 is connected via a fastening element 46 to a first coil 29 that is configured as a spiral spring 41 and that exerts a force directed into the lock body 13 onto the first rope section 19. The coil 29 is thereby a component of a drawing-in device 27 that enables an automatic drawing of the rope section 19 into the lock body 13 and its compact arrangement in windings 33 around the coil 29 (cf. FIG. 2).

As FIG. 5A shows, the lock body 13 has a blocking element 77, as part of a blocking device 55 provided for the first rope section 19, that is arranged in the region of the inlet opening 61 and that is spring-preloaded in a blocking direction B by a preload spring 79. The blocking direction B is in this respect oriented perpendicular to a straight-line direction of entry E along which the first rope section 19 runs into the lock body 13. Due to the spring preload, the blocking element 77 presses the first rope section 19 against an inner housing wall 81 formed by the lock body 13 so that the rope section 19 is clamped between the blocking element 77 and the inner housing wall 81. The drawing-in effect exerted by the drawing-in device 27 onto the rope section 19 can thereby be blocked and the part 23 of said rope section 19 extending outside the lock body 13 can be fixedly held at a desired length L1.

To be able to selectively, for example before a transport of the lock 11, draw the first rope section 19 into the lock body 13 by the drawing-in device 27 and to be able to arrange it in a compact manner, a user can bring the rope section 19 into an oblique orientation with respect to the direction of entry E shown in FIG. 5B in order to transfer a force acting against the blocking direction B to the blocking element 77 and to push the blocking element 77 back against the preload of the preload spring 79. The clamping of the rope section 19 between the blocking element 77 and the inner housing wall 81 can thereby be suspended so that the rope section 19 can be drawn in in a controlled and continuous manner and can be wound around the drawing-in device 27 in so doing. Alternatively to this, a button or a push-button can be provided at an outer side of the lock body 13 to be able to selectively push back such a spring-preloaded blocking element 77.

A further blocking element, as part of a second blocking device 57, configured in the same manner as the blocking element 77 can be provided for a second rope section 21 running into the lock body 13 so that the first blocking device 55 and the second blocking device 57 can form the fixing device 53 (cf. also FIG. 2).

The lock 11 allows an extremely compact arrangement directly at the bicycle frame 69 and thus in particular provides a comfortable securing possibility, without any restrictions of other functions, for bicycles used mainly for sports such as racing bikes or mountain bikes. The rope sections 19 or 21 can in this respect in particular be relatively thin and the lock 11 can thereby be formed with a low weight to be able to sufficiently protect such bicycles against an unauthorized riding away or removal during short breaks without the lock 11 representing an unreasonably large additional weight.

### REFERENCE NUMERAL LIST

11 lock

13 lock body

15 locking element

17 locking mechanism

19 first wire section

21 second wire section

23 part of the first rope section extending outside the lock body

25 part of the second rope section extending outside the lock body

27 drawing-in device

29 first coil

31 second coil

33 windings

35 housing

37 rear housing part

39 front housing part

41 spring

4 fastened spring end

43 first rope end

45 second rope end

46 fastening element

47 connection element

49 first fastening passage

50 boundary

51 second fastening passage

53 fixing device

55 first blocking device

57 second blocking device

59 sealing element

61 inlet opening

63 code ring

65 holder

67 bottle holder

69 bicycle frame

71 fastening screw

73 elongate hole

75 contact section

77 blocking element

79 preload spring

81 inner housing wall

A axis of rotation of the code rings

B blocking direction

E direction of entry

D1 first axis of rotation

D2 second axis of rotation

L1 length of the part of the first rope section extending outside the lock body

L2 length of the part of the second rope section extending outside the lock body

T division plane

W winding plane

1. A lock comprising
a lock body;
a locking element located outside the lock body; and
a locking mechanism located outside the lock body for receiving and locking the locking element,
wherein the locking mechanism is connected to the lock body by a first rope section and the locking element is connected to the lock body by a second rope section, and
wherein a length of a part of at least one of the first rope section and the second rope section extending outside the lock body is variable.

2. The lock in accordance with claim 1,
wherein the length of the part of each of the first rope section and the second rope section extending outside the lock body is variable.

3. The lock in accordance with claim 1,
wherein at least one of the first rope section and the second rope section may be drawn out of the lock body to change the length of the part of the at least one of the first rope section and the second rope section extending outside the lock body.

4. The lock in accordance with claim 1,
wherein at least one of the first rope section and the second rope section is connected to a drawing-in device arranged within the lock body for drawing in the at least one of the first rope section and the second rope section connected to the drawing-in device.

5. The lock in accordance with claim 4,
wherein the drawing-in device has at least one coil for winding up the at least one of the first rope section and the second rope section.

6. The lock in accordance with claim 5,
wherein the at least one coil comprises a spring whose spring force counteracts an unwinding of the at least one of the first rope section and the second rope section.

7. The lock in accordance with claim 5,
wherein the winding of the at least one of the first rope section and the second rope section is disposed in a winding plane.

8. The lock in accordance with claim 7,
wherein the winding of the first rope section and the second rope section are disposed in a common winding plane.

9. The lock in accordance with claim 7,
wherein the lock body forms a housing for the at least one coil and for the winding of the at least one of the first rope section and second rope section,
wherein the housing has a rear housing part and a front housing part that are connected to one another along a division plane, and
wherein the division plane is aligned in parallel with the winding plane or is disposed in the winding plane.

10. The lock in accordance with claim 4,
wherein the drawing-in device comprises a fixing device that is configured to block the drawing in of the at least one of the first rope section and the second rope section.

11. The lock in accordance with claim 10,
wherein the fixing device has a first blocking device for the first rope section that is configured to block the part of the first rope section extending outside the lock body at a predefinable length, and
wherein the fixing device has a second blocking device for the second rope section that is configured to block the part of the second rope section extending outside the lock body at a predefinable length.

12. The lock in accordance with claim 1,
wherein at least one of the first rope section and the second rope section terminates in a rope end within the lock body, the rope end being connected to a coil rotatable about an axis of rotation.

13. The lock in accordance with claim 1,
wherein the first rope section terminates in a first rope end within the lock body, the first rope end being connected to a first coil rotatable about a first axis of rotation, and
wherein the second rope section terminates in a second rope end within the lock body, the second rope end being connected to a second coil rotatable about a second axis of rotation.

14. The lock in accordance with claim 13,
wherein the first axis of rotation and the second axis of rotation are aligned in parallel with one another and a spacing of the first axis of rotation from the second axis of rotation is between 60 mm and 70 mm.

15. The lock in accordance with claim 13,
wherein the first coil and the second coil are connected to one another via a connection element.

16. The lock in accordance with claim 13,
wherein the lock body has a first fastening passage and a second fastening passage for leading through fastening screws, with the first fastening passage extending coaxially to the first axis of rotation and the second fastening passage extending coaxially to the second axis of rotation.

17. The lock in accordance with claim 1,
wherein sealing elements are provided for sealing inlet openings of the first rope section and the second rope section into the lock body.

18. The lock in accordance with claim 1,
wherein the locking mechanism is configured as a combination locking mechanism.

19. The lock in accordance with claim 1,
wherein the lock body has a holder for at least one of the locking mechanism and the locking element,
wherein the holder is formed as at least partly elastically deformable.

20. A bicycle comprising:
a bicycle frame having two threaded bores for fastening a bottle holder;
a bottle holder that is fastened to the bicycle frame by two fastening screws associated with the threaded bores; and
a lock that is arranged between the bottle holder and the bicycle frame and that is attached to the bicycle frame by the fastening screws, the lock comprising:
a lock body;
a locking element located outside the lock body; and
a locking mechanism located outside the lock body for receiving and locking the locking element,
wherein the locking mechanism is connected to the lock body by a first rope section and the locking element is connected to the lock body by a second rope section, and
wherein a length of a part of at least one of the first rope section and the second rope section extending outside the lock body is variable.
